(19) United States
(12) Patent Application Publication
(10) Pub. No.: US 2018/0311651 A1
(43) Pub. Date: Nov. 1, 2018

(54) USE OF HOLLOW ZEOLITES DOPED WITH BIMETALLIC OR TRIMETALLIC PARTICLES FOR HYDROCARBON REFORMING REACTIONS

(71) Applicant: SABIC Global Technologies B.V., Bergen op Zoom (NL)

(72) Inventors: Ugo Ravon, Thuwal (SA); Lawrence D'Souza, Thuwal (SA); Vinu Viswanath, Thuwal (SA)

(21) Appl. No.: 15/770,576

(22) PCT Filed: Oct. 27, 2016
(86) PCT No.: PCT/IB2016/056478

§ 371 Date: Apr. 24, 2018

Related U.S. Application Data
(60) Provisional application No. 62/248,665, filed on Oct. 30, 2015.

(51) Int. Cl. B01J 29/035; B01J 23/755; B01J 23/89; B01J 35/00; B01J 37/02; B01J 37/00; B01J 37/08; C01B 3/40

(52) U.S. Cl. CPC B01J 29/035; B01J 23/755; B01J 23/892; B01J 35/0006; B01J 35/0013; B01J 37/0201; C01B 2203/1241; B01J 37/08; C01B 3/40; C01B 2203/0238; C01B 2203/1082; C01B 2203/1064; C01B 2203/1058; B01J 37/0018

(57) ABSTRACT

Catalysts useful for hydrocarbon reforming reactions are described. A catalyst can include a bimetallic (M1M2) or trimetallic (M1M2M3) nanostructure, or oxides thereof, and a hollow zeolite support. The hollow space in the zeolite support includes the bi-metallic (M1M2) or tri-metallic (M1M2M3) nanostructure, or oxides thereof.

### CROSS REFERENCE TO RELATED APPLICATIONS

This application claims the benefit of priority of U.S. Provisional Patent Application No. 62/248,665, filed Oct. 30, 2015, which is hereby incorporated by reference in its entirety.

### BACKGROUND OF THE INVENTION

A. Field of the Invention

The invention generally concerns a catalyst for chemical applications (e.g., hydrocarbon reforming reactions such as dry or steam reforming of methane). In particular, the invention concerns a catalyst that includes a bimetallic (M¹M²) or trimetallic (M¹M²M³) nanostructure, or oxides thereof, and a hollow zeolite support. The hollow space in the zeolite support includes the bi-metallic (M¹M²) or tri-metallic (M¹M²M³) nanostructure, or oxides thereof.

B. Description of Related Art

Synthesis gas or “syngas” is a gas mixture that includes carbon monoxide and hydrogen. Syngas is typically used as an intermediary gas to produce a wide range of various products, such as mixed alcohols, hydrogen, ammonia, i-C₄ hydrocarbons, mixed alcohols, Fischer-Tropsch products (e.g., waxes, diesel fuels, olefins, gasoline, or the like), methanol, ethanol, aldehydes, alcohols, dimethoxy ethane, methyl tert-butyl ether, acetic acid, gas-to-liquids, butryaldehyde, or the like. Syngas can also be used as a direct fuel source, such as for internal combustible engines.

One of the more common methods of producing syngas is by oxidizing hydrocarbon gases such as methane. For instance, the controlled oxidation of methane can be carried out using carbon dioxide, water, oxygen, or a combination of such materials. For industrial scale applications, methane can be reformed into syngas by using steam, as shown in the following reaction:

CH₄+H₂O→CO+3H₂

The ratio of CO/H₂ obtained in steam reforming process is about 0.33. Many applications, however, require a CO/H₂ of about 1.0. Such applications include production of aldehydes, alcohols, acetic anhydride, acetic acid, ethers, and ammonia. Therefore, the current solution is to remove excess H₂ from the produced syngas using separation techniques, which can decrease efficiency while simultaneously increasing associated costs. Alternatively, the ratio of CO/H₂ may be increased to about 1.0 by utilizing the dry reforming of methane reaction. In dry reforming of methane, methane is reacted with carbon dioxide or a mixture of carbon dioxide and oxygen as shown in the following equations:

CH₄+CO₂→2CO+2H₂

2CH₄+CO₂+O₂→3CO+3H₂+H₂O

Several metals, example Pt, Pd, Au, Ag, Ir, Ni, Co, Rh, Ru, La, Mg, Ca, Sr, Ba, Li, Na, K and Mn supported on different metal oxides, for example, Al₂O₃, SiO₂, ZrO₂, TiO₂, CeO₂, MgO, ZSM-5, MCM-41, MgAl₂O₄ have been used reforming processes. Of these catalysts, noble metal catalysts for CO₂ reforming are based on Ni, Pt, Rh and Ru supported on Al₂O₃. One problem associated with dry reforming (using carbon dioxide) of methane is that current catalysts are prone to sintering, which reduces the active surface of the catalyst. Other problems associated with steam reforming and dry methane reforming reactions include growth of carbon residuals (e.g., encapsulating carbon, amorphous carbon, carbon whisker, filamentous carbon, and graphite) on the surface of the supported catalyst. Carbon growth can lead to deactivation of the catalyst due to blockage of catalytic sites (e.g., metal sites, coking), degradation of the catalyst, reactor plugging or combinations thereof.

Several recent disclosures have focused on improving the activity and life of reforming catalysts by attempting to reduce the particle size of the catalytic metal, use of promoters, or encapsulating the catalytic metal in a metal oxide by forming core@shell type structures. In some instances, single metal encapsulated hollow zeolites have been developed for use in various chemical applications. By way of example, Li et al., “Ultimate size control of encapsulated gold nanoparticles,” Chem. Commun. 2013, 49, describes encapsulating a single gold nanoparticle in a hollow zeolite. Still further, Li, “Metal nanoparticles encapsulated in membrane-like zeolite single crystals: application to selective catalysis,” Ph.D. Thesis, L'Universite Claude Bernard Lyon 1, HAL Id: tel-1163661, June 2015, describes the encapsulation of single metals such as cobalt, nickel, and copper in hollow zeolites for use as hydrogenation catalysts. Dai et al., “Hollow zeolite encapsulated Ni—Pt bimetals for sintering and coking resistant dry reforming of methane”, J. Materials of Chemistry A, 2015, 3, 16461-16468, describes encapsulating nickel—platinum nanoparticles in hollow zeolite for us in dry reforming of methane reactions.

Despite all of the currently available research on encapsulated metal hollow zeolite catalysts, many of the resulting catalysts include expensive noble metals, which can unfavorably impact costs for commercial applications.

### SUMMARY OF THE INVENTION

A solution to the problems associated with the costs, deactivation, and degradation of reforming catalysts has been discovered. The solution lies in the production of alternatives to the Ni/Pt bimetallic catalysts, which can be expensive and can have limited efficiencies in hydrocarbon reforming reactions. In particular, the solution of the present invention concerns catalysts having bimetallic or trimetallic nanostructures encapsulated in a hollow zeolite structure that can be used in all types of hydrocarbon reforming reactions. As show in non-limiting embodiments in the Examples, NiCo bimetallic and NiRu bimetallic particles encapsulated in the hollow zeolite structure provide good stability and efficiency in hydrocarbon reforming reactions. Even further, the use of trimetallic nanostructures provides another class of catalysts that can be used in these types of reactions. Without wishing to be bound by theory, it is believed that certain combinations of bimetallic and trimetallic nanostructures that are encapsulated in the hollow zeolite structure offer increased catalytic stability and efficiency in producing syngas from either dry or steam reforming reactions of hydrocarbons (e.g., dry or steam reforming of methane). The size of the bimetallic or trimetallic particles are believed to be sufficiently small to prevent coking yet sufficiently large enough to be retained inside the hollow zeolite structure and prevent sintering with other metallic particles.

In a particular aspect of the present invention, there is disclosed a supported catalyst that can include a bimetallic (M¹M²) or trimetallic (M¹M²M³) nanostructure, or oxides thereof, encapsulated in a hollow zeolite support where M¹, M², and if present, M³, are different, with the proviso that if M¹ is Ni, then M² is not Pt in the bimetallic (M¹M²) nanostructure. The catalyst can be used to catalyst reformation of hydrocarbons (e.g., CO₂ reformation (dry reformation) or steam reformation of hydrocarbons (e.g., methane). The hydrocarbons can include 1, 2, 3, 4 6, 7, or 8 carbon atoms. In preferred aspects, the hydrocarbon can be methane. The supported catalyst includes at least two metals from Columns 1-16 of the Periodic Table. In a particular instance, when the catalyst includes a bimetallic nanostructure or oxide thereof, M¹ is cobalt (Co) and M² is ruthenium (Ru). Non-limiting examples of trimetallic catalysts can include (M¹M²M³) nickel/cobalt/ruthenium (Ni/Co/Ru), nickel/cobalt/rhodium (Ni/Co/Rh), nickel/cobalt/platinum (Ni/Co/Pt), nickel/cobalt/cerium Ni/Co/Ce, or any combination thereof. The hollow zeolite support can include an exterior surface and an interior surface that defines and encloses a hollow space within the interior of the support and the bi-metallic (M¹M²) or tri-metallic (M¹M²M³) nanostructure, or oxides thereof, can be included in the hollow space. The hollow zeolite support can be made from any zeolite support (e.g., silicate-1, MFI, FAU, ITH BEA, MOR, LTA, MWW, CHA, MRE, MFE, or a VFI support). In one embodiment, MFI is used as the hollow support. In some aspects, the hollow zeolite support is 80 to 99.5 wt. % of the supported catalyst. The hollow space in the zeolite and the bi-metallic (M¹M²) or tri-metallic (M¹M²M³) nanostructure, or oxides thereof, included in the hollow space can be larger than the average pore size of the pores in the hollow zeolite support. The hollow space can include only one or a plurality of the bimetallic (M¹M²) or trimetallic (M¹M²M³) nanostructures, or oxides thereof. An average particle size of the bimetallic (M¹M²) or trimetallic (M¹M²M³) nanostructure, or oxides thereof, can range least 1 to 100 nm, preferably 1 to 30 nm, more preferably 3 to 15 nm, most preferably ≤10 nm with a size distribution having a standard deviation of ±20%. In certain aspects, the bimetallic (M¹M²) or trimetallic (M¹M²M³) nanostructures, or oxides thereof can be deposited on the interior surface of the hollow space. Additional bimetallic (M¹M²) or trimetallic (M¹M²M³) nanostructures, or oxides thereof can be deposited on the exterior surface. An amount of M¹ and M² are each 1 to 20 weight % of the total weight of the bimetallic nanostructure or M¹, M², and M³ are each 1 to 20 weight % of the total weight of the trimetallic nanostructure.

Methods of reforming hydrocarbons are disclosed. In one method, hydrogen (H₂) and carbon monoxide (CO) can be produced by contacting a hydrocarbon feed stream with the catalyst described above in the presence of carbon dioxide (CO₂) or H₂O. Coke formation on the supported nanostructure catalyst is substantially or completely inhibited. In some embodiments, the reactant stream can include methane and CO₂, methane, water and, optionally O₂, or methane, CO₂, and water. Reformation reaction conditions can include a temperature of about 700° C. to about 950° C., a pressure of about 0.1 MPa to 2.5 MPa, and a gas hourly space velocity (GHSV) ranging from about 500 to about 100,000 h⁻¹.

In another aspect, a method to make the supported catalyst described above can include (a) obtaining a zeolite support, (b) obtaining a first suspension by suspending the zeolite support in an aqueous solution having a M¹ precursor material, a M² precursor material, and optionally a M³ precursor material for a sufficient period of time to impregnate the support with the precursor material and drying the first suspension to obtain an impregnated support, (c) obtaining a second suspension by suspending the impregnated support from step (b) in an aqueous solution that includes a templating agent and heat treating the suspension to obtain a templated support, and (d) calcining the templated support to obtain the supported catalyst described above. Drying the first suspension to obtain the impregnated support in step (b) can include subjecting the first suspension to a temperature of 30° C. to 100° C., preferably 40° C. to 60° C., for 4 to 24 hours, preferably 6 to 12 hours. The calcining step (d) can include subjecting the templated support to a temperature of 350° C. to 550° C., preferably 400° C. to 500° C., for 3 to 10 hours, preferably 4 to 8 hours. M¹, M², and M³ precursor materials can each be a metal nitrate, a metal amine, a metal chloride, a metal coordination complex, a metal sulfate, a metal phosphate hydrate, or combination thereof. Tetrapropylammonium hydroxide (TPAOH) can be used as the templating agent. The calcined catalyst can be subjecting to reducing conditions to convert the metal oxide to the metal having a zero valence.

Systems for producing a chemical product are also described. A system can include (a) an inlet for a reactant feed, (b) a reaction zone (e.g., a continuous flow reactor selected from a fixed-bed reactor, a fluidized reactor, or a moving bed reactor) that is configured to be in fluid communication with the inlet, and (c) an outlet configured to be in fluid communication with the reaction zone and configured to remove a product stream from the reaction zone. The reaction zone can include the supported catalyst of the present invention. The reactant feed can include C₁ to C₈ hydrocarbons (e.g., methane, C₁ to C₃ hydrocarbons, C₁ to C₄ hydrocarbons, or the like) and an oxidant (e.g., carbon dioxide, oxygen or air), water or both.

In the context of the present invention 35 embodiments are described. Embodiment 1 is a supported catalyst that includes a bimetallic (M¹M²) or trimetallic (M¹M²M³) nanostructure, or oxides thereof, and a hollow zeolite support, wherein: (a) M¹, M², and if present, M³, are different, with the proviso that if M¹ is Ni, then M² is not platinum (Pt) in the bimetallic (M¹M²) nanostructure; and (b) the hollow zeolite support comprises an exterior surface and an interior surface that defines and encloses a hollow space within the interior of the support, wherein the bi-metallic (M¹M²) or tri-metallic (M¹M²M³) nanostructure, or oxides thereof, is comprised in the hollow space. Embodiment 2 is the supported catalyst of embodiment 1, wherein the hollow zeolite support is a silicate-1, MFI, FAU, ITH BEA, MOR, LTA, MWW, CHA, MRE, MFE, or a VFI support, preferably an MFI support. Embodiment 3 is the supported catalyst of any one of embodiments 1 to 2, wherein the nanostructure is a bimetallic (M¹M²) nanoparticle. Embodiment 4 is the supported catalyst of embodiment 3, wherein M¹ is Ni and M² is either Co or Ru. Embodiment 5 is the supported catalyst of embodiment 4, wherein M¹ and M² are each 45 to 55 molar % of the total moles of the bimetallic nanostructure. Embodiment 6 is the supported catalyst of embodiment 5, wherein the hollow zeolite support is 80 to 99.5 wt. % of the supported catalyst. Embodiment 7 is the supported catalyst of any one of embodiments 1 to 6, wherein the hollow space comprises only one bimetallic (M¹M²) or trimetallic (M¹M²M³) nanoparticle, or oxides thereof. Embodiment 8 is the supported catalyst of any one of embodiments 1 to 6, wherein the hollow space comprises a plurality of the bimetallic (M¹M²) or trimetallic (M¹M²M³) nanoparticles, or oxides thereof. Embodiment 9 is the supported catalyst of any one of embodiments 1 to 8, wherein the bimetallic (M¹M²) or trimetallic (M¹M²M³) nanoparticle, or oxides thereof, is deposited on the interior surface. Embodiment 10 is the supported catalyst of any one of embodiments 1 to 9, further comprising at least one additional bimetallic (M¹M²) or trimetallic (M¹M²M³) nanoparticle, or oxides thereof, deposited on the exterior surface. Embodiment 11 is the supported catalyst of any one of embodiments 1 to 10, wherein the size of the hollow space and the bimetallic (M¹M²) or trimetallic (M¹M²M³) nanoparticle, or oxides thereof, are larger than the average pore size of the pores in the hollow zeolite support. Embodiment 12 is the supported catalyst of embodiment 11, wherein the average particle size of the bimetallic (M¹M²) or trimetallic (M¹M²M³) nanoparticle, or oxides thereof, is 1 to 100 nm, preferably 1 to 30 nm, more preferably 3 to 15 nm, most preferably ≤10 with a size distribution having a standard deviation of ±20%. Embodiment 13 is the supported catalyst of any one of embodiments 1 to 4 and 7 to 12, wherein M¹ and M² are each 1 to 20 weight % of the total weight of the bimetallic nanostructure or wherein M¹, M², and M³ are each 1 to 20 weight % of the total weight of the trimetallic nanostructure. Embodiment 14 is the supported catalyst of any one of embodiments 1 to 4 and 7 to 13, wherein the hollow zeolite support is 80 to 99.5 wt. % of the supported catalyst. Embodiment 15 is the supported catalyst of any one of embodiments 1 to 14, wherein the catalyst is configured to catalyze a hydrocarbon reformation reaction. Embodiment 16 is the supported catalyst of embodiment 15, wherein the reformation reaction is a dry reformation of methane reaction or a steam reformation reaction. Embodiment 17 is the supported catalyst of embodiment 15, wherein the reformation reaction of methane reaction is a steam reformation reaction.

Embodiment 18 is a method of producing H₂ and CO that includes contacting a reactant gas stream that includes hydrocarbons and CO₂ or H₂O with the supported catalyst of any one of embodiments 1 to 17 sufficient to produce a product gas stream comprising H₂ and CO. Embodiment 19 is the method of embodiment 18, wherein coke formation on the supported nanostructure catalyst is substantially or completely inhibited. Embodiment 20 is the method of any one of embodiments 18 to 19, wherein the reactant gas stream comprises C₁ to C₈ hydrocarbons, preferably methane, and CO₂. Embodiment 21 is the method of any one of embodiments 18 to 19, wherein the reactant gas stream comprises C₁ to C₈ hydrocarbons, preferably methane, and H₂O and optionally O₂. Embodiment 22 is the method of any one of embodiments 18 to 19, wherein the reactant gas stream comprises C₁ to C₈ hydrocarbons, preferably methane, and H₂O and CO₂ and H₂O. Embodiment 23 is the method of any one of embodiments 18 to 22, wherein the reaction conditions include a temperature of about 700° C. to about 950° C., a pressure of about 0.1 MPa to 2.5 MPa, and a gas hourly space velocity (GHSV) ranging from about 500 to about 100,000 h⁻¹.

Embodiment 24 is a method of making the supported catalyst of any one of embodiments 1 to 17. The method can include: (a) obtaining a zeolite support; (b) obtaining a first suspension by suspending the zeolite support in an aqueous solution having a M¹ precursor material, a M² precursor material, and optionally a M³ precursor material for a sufficient period of time to impregnate the support with the precursor material and drying the first suspension to obtain an impregnated support; (c) obtaining a second suspension by suspending the impregnated support from step (b) in an aqueous solution comprising a templating agent and thermally treating the suspension to obtain a templated support; and (d) calcining the templated support to obtain the supported catalyst of any one of embodiments 1 to 17. Embodiment 25 is the method of embodiment 24, wherein drying the first suspension to obtain the impregnated support in step (b) comprises subjecting the first suspension to a temperature of 30° C. to 100° C., preferably 40° C. to 60° C., for 4 to 24 hours, preferably 6 to 12 hours. Embodiment 26 is the method of any one of embodiments 24 to 25, wherein thermally treating the second suspension to obtain the templated support comprises subjecting the second suspension to a temperature of 100° C. to 250° C., preferably 150° C. to 200° C., for 12 to 36 hours, preferably 18 to 30 hours. Embodiment 27 is the method of any one of embodiments 24 to 26, wherein calcining step (d) comprises subjecting the templated support to a temperature of 350° C. to 550° C., preferably 400° C. to 500° C., for 3 to 10 hours, preferably 4 to 8 hours. Embodiment 28 is the method of any one of embodiments 24 to 27, wherein the M¹, M², and M³ precursor materials are each a metal nitrate, a metal amine, a metal chloride, a metal coordination complex, a metal sulfate, a metal phosphate hydrate, or combination thereof. Embodiment 29 is the method of any one of embodiments 24 to 27, wherein the templating agent is tetrapropylammonium hydroxide (TPAOH).

Embodiment 30 is a system for producing a chemical product. The system can include: (a) an inlet for a reactant feed; (b) a reaction zone that is configured to be in fluid communication with the inlet, wherein the reaction zone comprises the supported catalyst of any one of embodiments 1 to 17; and (c) an outlet configured to be in fluid communication with the reaction zone and configured to remove a product stream from the reaction zone. Embodiment 31 is the system of embodiment 30, wherein the reaction zone is a continuous flow reactor selected from a fixed-bed reactor, a fluidized reactor, or a moving bed reactor. Embodiment 32 is the system of any one of embodiments 30 to 31, wherein the reactant feed is a gas stream comprising CH₄ and CO₂. Embodiment 33 is the system of any one of embodiments 30 to 31, wherein the reactant feed is a gas stream comprising CH₄, CO₂, and H₂O. Embodiment 34 is the system of any one of embodiments 30 to 31, wherein the reactant feed is a gas stream comprising CH₄ and H₂O and optionally O₂. Embodiment 35 is the system of any one of claims 30 to 34, wherein the product stream is a gas stream comprising H₂ and CO.

The following includes definitions of various terms and phrases used throughout this specification.

“Nanostructure” refers to an object or material in which at least one dimension of the object or material is equal to or less than 1000 nm (e.g., one dimension is 1 to 1000 nm in size). In a particular aspect, the nanostructure includes at least two dimensions that are equal to or less than 1000 nm (e.g., a first dimension is 1 to 1000 nm in size and a second dimension is 1 to 1000 nm in size). In another aspect, the nanostructure includes three dimensions that are equal to or less than 1000 nm (e.g., a first dimension is 1 to 1000 nm in size, a second dimension is 1 to 1000 nm in size, and a third dimension is 1 to 1000 nm in size). The shape of the nanostructure can be of a wire, a particle (e.g., having a substantially spherical shape), a rod, a tetrapod, a hyper-branched structure, a tube, a cube, or mixtures thereof “Nanostructures” include particles having an average diameter size of 1 to 1000 nanometers. In a particular instance, the nanostructure is a nanoparticle.

The term “about” or “approximately” are defined as being close to as understood by one of ordinary skill in the art. In one non-limiting embodiment, the terms are defined to be within 10%, preferably within 5%, more preferably within 1%, and most preferably within 0.5%.

The term “substantially” and its variations are defined to include to ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising”, “including”, “containing”, or “having” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The catalysts of the present invention can “comprise,” “consist essentially of,” or “consist of” particular ingredients, components, compositions, etc. disclosed throughout the specification. With respect to the transitional phase “consisting essentially of,” in one non-limiting aspect, a basic and novel characteristic of the catalysts of the present invention are (1) the use of bimetallic or trimetallic nanostructures that are encapsulated in a hollow zeolite structure and (2) their use in catalyzing hydrocarbon reforming reactions.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIG. 1A is an illustration of an embodiment of cross-sectional view of an encapsulated nanostructure in a hollow zeolite with the nanostructure contacting the inner surface of the hollow space.

FIG. 1B is an illustration of an embodiment of cross-sectional view of an encapsulated nanostructure in a hollow zeolite with the nanostructure not contacting the inner surface of the hollow space.

FIG. 1C is an illustration of an embodiment of cross-sectional view of encapsulated nanostructures in a hollow zeolite with the nanostructure.

FIG. 2 is an illustration of a method of making the encapsulated nanostructure in a hollow zeolite.

FIG. 3 shows isothermal plots of silicate-1 and hollow silicate-1.

FIGS. 4A-C are transmission electron microscope (TEM) images of hollow zeolite (silicate-1) at various magnifications.

FIG. 4D is a TEM image of nickel oxide (NiO) in a hollow zeolite.

FIG. 4E is a TEM image of the bimetallic NiCo in a hollow zeolite.

FIG. 4F is a TEM image of bimetallic NiRu in a hollow zeolite.

FIG. 5 shows graphs of methane conversion in percent versus time of stream in hours for comparative samples and NiCo/HZ and NiRu/HZ catalysts of the present invention (“HZ” referring to hollow zeolite).

FIG. 6 shows graphs of percent carbon dioxide conversion in percent versus time of stream in hours for comparative samples and NiCo/HZ and NiRu/HZ catalysts of the present invention (“HZ” referring to hollow zeolite).

FIG. 7 shows graphs of hydrogen/carbon dioxide ratios versus time of stream in hours for comparative samples and NiCo/HZ and NiRu/HZ catalysts of the present invention (“HZ” referring to hollow zeolite).

While the invention is susceptible to various modifications and alternative forms, specific embodiments thereof are shown by way of example in the drawings and may herein be described in detail. The drawings may not be to scale.

### DETAILED DESCRIPTION OF THE INVENTION

The currently available commercial catalysts used to reform hydrocarbons into syngas are prone to growth of carbon residuals (e.g., coke and carbon whiskers) and sintering which can lead to inefficient catalyst performance and ultimately failure of the catalyst after relatively short periods of use. This can lead to inefficient syngas production as well as increased costs associated with its production. A discovery has been made that avoids problems associated with deactivation of reforming catalysts and the expense of using platinum or Ni—Pt catalysts. The catalyst is based on encapsulating a bimetallic (M¹M²) or a trimetallic (M¹M²M³) nanostructure in a hollow space of a zeolite. Notably, the catalyst does not rely on the presence of Pt such as Ni—Pt nanostructures. The catalyst design allows for low loading of less expensive catalytic metals and provides catalytic activity at lower temperatures (e.g., 650° C.). The nanostructure used in the catalyst can be selected for a desired result (e.g., catalytic metals can be included in the hollow to catalyze a given reformation reaction). The method of making the catalyst allows for creation of a hollow space in the zeolite and subsequent encapsulation of the metal nanostructure in the hollow zeolite. The method also allows control of the size the metal nanostructure. Without wishing to be bound by theory it is believed that because the metal nanostructure size is larger than the pore size of the zeolite, the metal nanostructure cannot diffuse out of the zeolite so they remain inside the hollow space of the zeolite created. Thus, the particle cannot grow or sinter, and hence size is maintained (i.e., sintering is prevented or inhibited). Moreover, because the size of the metal nanostructure is reduced, the formation of coke can be inhibited. Furthermore, the methods used to prepare the catalysts of the present invention allow tuning of the size of the bimetallic or trimetallic nanostructures as well as the type of metals that can be used. Further, the thickness of the hollow zeolite shell can also be tuned as desired.

These and other non-limiting aspects of the present invention are discussed in further detail in the following sections.

### A. Catalyst Structure

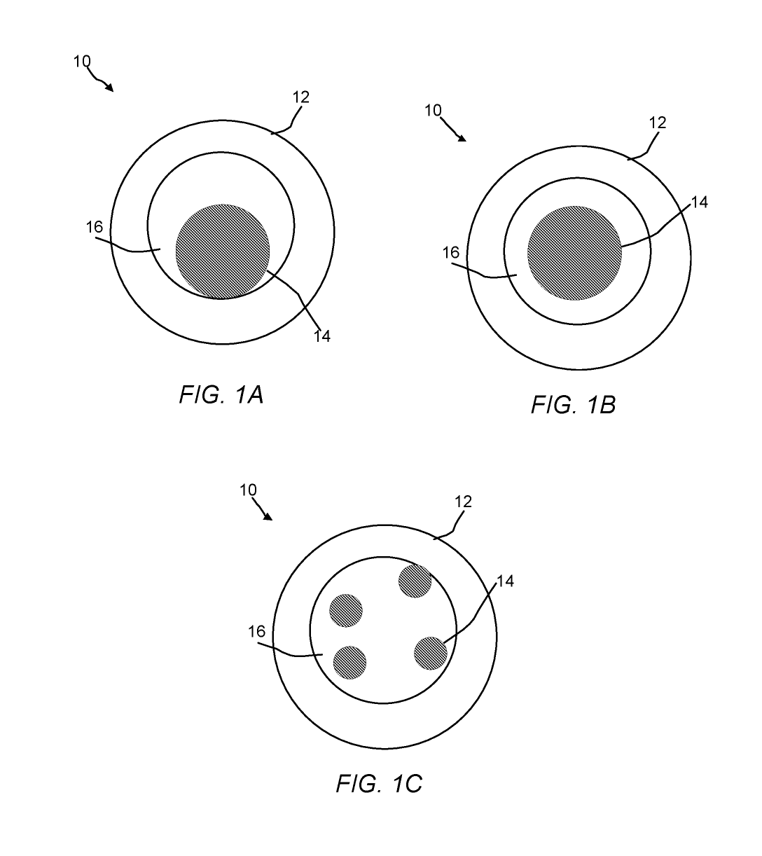

The metal nanostructure/hollow zeolite structure of the present invention includes a metal nanostructure contained within a hollow space that is present in the zeolite. FIGS. 1A through 1C are cross-sectional illustrations of catalyst material 10 having an encapsulated metal nanostructure/hollow zeolite structure. The catalyst material 10 has a zeolite shell 12, a bimetallic or trimetallic nanostructure 14 and hollow space 16. In some embodiments, a portion of the nanostructure 14 (e.g., M¹ and M² and/or M³) can be deposited on the surface of the zeolite (not shown). As discussed in detail below, the hollow space 16 can be formed by removal of a portion of the zeolite core during the making of the catalyst material. As shown in FIG. 1A, the bimetallic or trimetallic nanostructure 14 contacts a portion of the inner wall of hollow space 16. As shown in FIG. 1B, the bimetallic or trimetallic nanostructure 14 does not contact the walls of the hollow space 16. As shown in FIG. 1C, multiple bimetallic or trimetallic nanostructures 14 are in hollow space 16 with some bimetallic or trimetallic nanostructures touching the inner wall of the hollow space. In certain aspects, 1% to 99%, 10% to 80%, 20% to 70%, 30% to 60%, 40% to %0% or any range or value there between of the nanostructures fills the hollow space 16. A diameter of the bimetallic or trimetallic nanostructure 14 can range from 1 nm to 100 nm, preferably 1 nm to 50 nm, or more preferably 1 nm to 5 nm or any value or range there between. In some embodiments, 1 to 100 nm, preferably 1 to 30 nm, more preferably 3 to 15 nm, most preferably ≤10 nm with a size distribution having a standard deviation of ±20%. The pore size of the catalyst is the same or similar to the pore size of the starting zeolite (e.g., about 5.5 Å). A volume space of the hollow space can be about 30 to 80%, 40 to 70%, or 50 to 60% of the zeolite particle volume or 30%, 35%, 40%, 45%, 50%, 55%, 60%, 65%, 70%, 75%, 80% or any value or range there between.

1. Bimetallic or Trimetallic Nanostructure

Nanostructure(s) 14 can include one or more two or more active (catalytic) metals to promote the reforming of methane to carbon dioxide. The nanostructure(s) 14 can include one or more metals from Columns 1-16 of the Periodic Table (Groups IA, IIA, IIIB, IVB, VB, VIB, VIIB, VIIIB, IB, IIB, IIIA, IVA, VA or VIA of the Chemical Abstracts Periodic Table). Non-limiting examples of the active metals include nickel (Ni), rhodium (Rh), ruthenium (Re), iridium (Ir), platinum (Pt), palladium (Pd), gold (Au), silver (Ag), cobalt (Co), manganese (Mn), copper (Cu), or any combination thereof, preferably combinations of nickel, cobalt and ruthenium (e.g., Ni—Co or Ni—Ru). The metals can be obtained from metal precursor compounds. For example, the metals can be obtained as a metal nitrate, a metal amine, a metal chloride, a metal coordination complex, a metal sulfate, a metal phosphate hydrate, metal complex, or any combination thereof. Examples of metal precursor compounds include, nickel nitrate hexahydrate, nickel chloride, cobalt nitrate hexahydrate, cobalt chloride hexahydrate, cobalt sulfate heptahydrate, cobalt phosphate hydrate, or ruthenium chloride, diammonium hexachorouthenate, hexammineruthenium trichloride, pentaammineruthenium dichloride, or the like. These metals or metal compounds can be purchased from any chemical supplier such as Sigma-Aldrich (St. Louis, Mo., USA), Alfa-Aeaser (Ward Hill, Mass., USA), and Strem Chemicals (Newburyport, Mass., USA).

The amount of nanostructure catalyst depends, inter alia, on the use of the catalysts (e.g., steam reforming or dry reforming of hydrocarbons). In some embodiments, the amount of catalytic metal present in the particle(s) in the hollow ranges from 0.01 to 100 parts by weight of catalyst per 100 parts by weight of catalyst, from 0.01 to 5 parts by weight of catalyst per 100 parts by weight of catalyst. M¹ and M² are each 1 to 20 weight % of the total weight of the bimetallic nanostructure or wherein M¹, M², and M³ are each 1 to 20 weight % of the total weight of the trimetallic nanostructure. A molar amount of each metal (e.g., M¹ and M² or M¹, M², and M³) in the nanostructure 14 ranges from 1 to 95 molar %, or 10 to 80 molar %, 50 to 70 molar % of the total moles of the bimetallic nanostructure. An average particle size of the bimetallic (M¹M²) or trimetallic (M¹M²M³) nanoparticle, or oxides thereof, is 1 to 100 nm, preferably 1 to 30 nm, more preferably 0.7 to 10 nm, most preferably ≤10 nm with a size distribution having a standard deviation of ±20%.

2. Zeolite Material

The zeolite shell 12 can be any porous zeolite or zeolite-like material. Zeolites belong to a broader material category known as “molecular sieves” and are often referred as such. Zeolites have uniform, molecular-sized pores, and can be separated based on their size, shape and polarity. For example, zeolites may have pore sizes ranging from about 0.3 nm to about 1 nm. The crystalline structure of zeolites can provide good mechanical properties and good thermal and chemical stability. The zeolite material can be a naturally occurring zeolite, a synthetic zeolite, a zeolite that have other materials in the zeolite framework (e.g., phosphorous), or combinations thereof. X-ray diffraction (XRD) analysis and scanning electron microscopy (SEM) may be carried out to determine the properties of zeolite materials, including their crystallinity, size and morphology. The network of such zeolites is made up of SiO₄ and AlO₄ tetrahedra which are joined via shared oxygen bridges. An overview of the known structures may be found, for example, in W. M. Meier, D. H. Olson and Ch. Baerlocher, “Atlas of Zeolite Structure Types”, Elsevier, 5th edition, Amsterdam 2001. Non-limiting examples of zeolites include ABW, ACO, AEI, AEL, AEN, AET, AFG, AFI, AFN, AFO, AFR, AFS, AFT, AFX, AFY, AHT, ANA, APC, APD, AST, ATN, ATO, ATS, ATT, ATV, AWO, AWW, *BEA, BIK, BOG, BPH, BRE, CAN, CAS, CFI, CGF, CGS, CHA, CHI, -CLO, CON, CZP, DAC, DDR, DFO, DFT, DOH, DON, EAB, EDI, EMT, EPI, ERI, ESV, EUO, *EWT, FAU, FER, GIS, GME, GOO, HEU, IFR, ISV, ITE, ITH, ITG, JBW, KFI, LAU, LEV, LIO, LOS, LOV, LTA, LTL, LTN, MAZ, MEI, MEL, MEP, MER, MFI, MFS, MON, MOR, MSO, MTF, MTN, MTT, MTW, MWW, NAT, NES, NON, OFF, OSI, PAR, PAU, PHI, RHO, RON, RSN, RTE, RTH, RUT, SAO, SAT, SBE, SBS, SBT, SFF, SGT, SOD, STF, STI, STT, TER, THO, TON, TSC, VET, VFI, VNI, VSV, WIE, WEN, YUG and ZON structures and mixed structures of two or more of the abovementioned structures. In some embodiments, the zeolite includes phosphorous to form a AIPOx structure. Non-limiting examples of AIPOx zeolites include AABW, AACO, AAEI, AAEL, AAEN, AAET, AAFG, AAFI, AAFN, AAFO, AAFR, AAFS, AAFT, AAFX, AAFY, AAHT, AANA, AAPC, AAPD, AAST, AATN, AATO, AATS, AATT, AATV, AAWO, AAWW, ABEA, ABIK, ABOG, ABPH, ABRE, ACAN, ACAS, ACFI, ACGF, ACGS, ACHA, ACHI, A-CLO, ACON, ACZP, ADAC, ADDR, ADFO, ADFT, ADOH, ADON, AEAB, AEDI, AEMT, AEPI, AERI, AESV, AEUO, A*EWT, AFAU, AFER, AGIS, AGME, AGOO, AHEU, AIFR, AISV, AITE, AITH, AITG, AJBW, AKFI, ALAU, ALEV, ALIO, ALOS, ALOV, ALTA, ALTL, ALTN, AMAZ, AMEI, AMEL, AMEP, AMER, AMFI, AMFS, AMON, AMOR, AMSO, AMTF, AMTN, AMTT, AMTW, AMWW, ANAT, ANES, ANON, AOFF, AOSI, APAR, APAU, APHI, ARHO, ARON, ARSN, ARTE, ARTH, ARUT, ASAO, ASAT, ASBE, ASBS, ASBT, ASFF, ASGT, ASOD, ASTF, ASTI, ASTT, ATER, ATHO, ATON, ATSC, AVET, AVFI, AVNI, AVSV, AWIE, AWEN, AYUG and AZON structures and mixed structures of two or more of the abovementioned structures. In particular embodiments, the zeolite is a porous zeolite in pure silica (Si/Al=∞) form or with a small amount of Al, for example, MFI, MEL, ITH, MOR, MWW or BEA framework type zeolites. Non-limiting examples of specific zeolites include L-zeolite, X-zeolite, Y-zeolite, omega zeolite, beta zeolite, silicate-1, TS-1, beta, ZSM-4, ZSM-5, ZSM-10, ZSM-12, ZSM-20, REY, USY, RE-USY, LZ-210, LZ-20-A, LZ-20-M, LZ-20-T, SSZ-24, ZZA-26, SSZ-31, SSZ-33, SSZ-35, SSZ-37, SSZ-41, SSZ-42, SSZ-44, MCM-58, mordenite, faujasite, or combinations thereof. Zeolites may be obtained from a commercial manufacturer such as Zeolyst (Valley Forge, Pa., U.S.A.).

### B. Preparation Encapsulated Nanoparticle/Hollow Zeolite Material

Catalytic materials exist in various forms and their preparation can involve multiple steps. The catalysts can be prepared by processes known to those having ordinary skill in the art, for example the catalyst can be prepared by any one of the methods comprising liquid-liquid blending, solid-solid blending, or liquid-solid blending (i.e any of precipitation, co-precipitation, impregnation, complexation, gelation, crystallization, microemulsion, sol-gel, solvothermal, dissolution-recrystallization, hydrothermal, sonochemical, or combinations thereof).

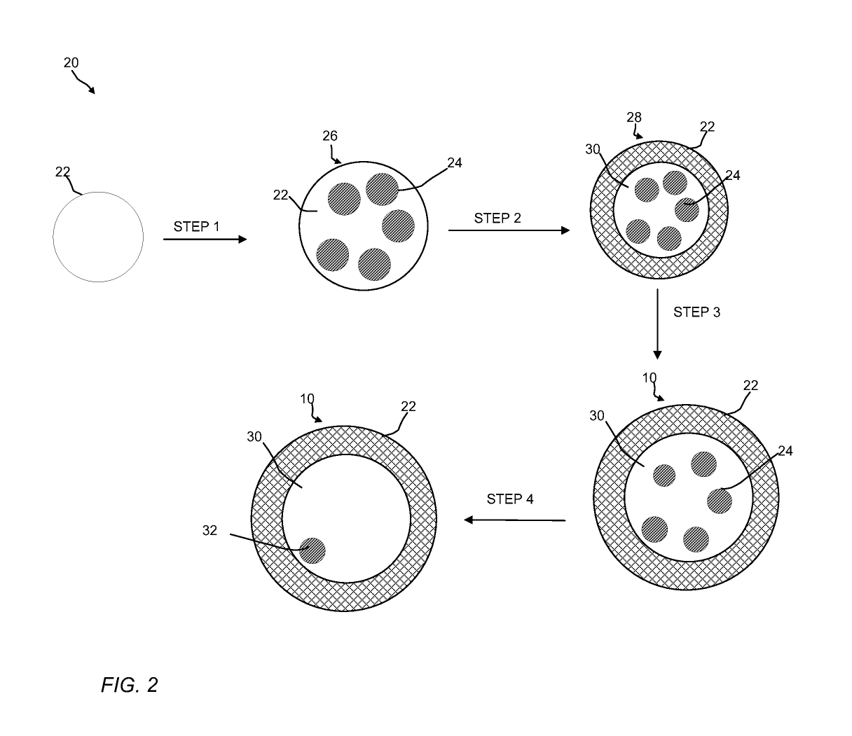

FIG. 2 is a schematic of an embodiment of a method to make the encapsulated metal nanoparticle/hollow shell zeolite material. In method 20, step 1, the zeolite material 22 can be obtained either through a commercial source or prepared using the methods described in the Examples section. An aqueous solution of the M¹ precursor material (e.g., a nickel precursor), a M² precursor material (e.g., ruthenium or cobalt precursors), and optionally a M³ precursor material can be contacted with the zeolite material to allow impregnation of the zeolite material with the precursor materials 24. The amount of solution of metal precursor material is the same or substantially the same as the pore volume of the zeolite material. The impregnated zeolite material can be dried to obtain a bimetallic or trimetallic impregnated zeolite material 26. Drying conditions can include heating the impregnated zeolite material 26 from 30° C. to 100° C., preferably 40° C. to 60° C., for 4 to 24 hours. In step 2, the impregnated zeolite material 26 can be contacted (suspended) with an aqueous solution of a templating agent (e.g., a quaternary ammonium hydroxide compound) and the resulting suspension is subjected to a dissolution-recrystallization process to produce the encapsulated nanoparticle/zeolite composite material 28 having metal nanostructures 24 positioned in hollow 30. In some embodiments, the zeolite is subjected to a vacuum prior to impregnation (e.g., 100 to 300° C. for 6 h under 10⁻⁶ bar) to facilitate metal diffusion through the pores. The dissolution-recrystallization process under hydrothermal conditions can include techniques of heating aqueous solutions of the aqueous templated zeolite suspension at high vapor pressures. In a particular embodiment, the suspension is heated to 100° C. to 250° C., preferably 150° C. to 200° C., for 12 to 36 hours, preferably 18 to 30 hours under autogenous pressure. Dissolution-recrystallization can performed in a pressure vessel, such as an autoclave, by a temperature-difference method, temperature-reduction method, or a metastable-phase technique. Without wishing to be bound by theory, it is believed that during the dissolution-recrystallization process, the hollow is formed in the zeolite framework through dissolution of some of the silicon core by the templating agent. The removed silica species can recrystallize on the outer surface upon cooling. During the hydrothermal process, the metal precursors can form a bimetallic or trimetallic nanostructure in the hollow space. Since the bimetallic or trimetallic particles are too large to migrate through the microporous zeolite walls, they remain in the hollow space. In some instances, small nanostructures come together and form a larger nanostructure or a single nanostructure in the hollow space. In step 3, the resulting metal-zeolite composite material 28 can be heated in the presence of air (e.g., calcined) to remove the template and any organic residues to form encapsulated bimetallic or trimetallic nanostructure/hollow zeolite material 10. Calcination conditions can include a temperature of 350° C. to 550° C., preferably 400° C. to 500° C. and a time of 3 to 10 hours, preferably 4 to 8 hours. In step 4, the encapsulated bimetallic or trimetallic nanostructure/hollow zeolite material 28 can be subjected to conditions sufficient to reduce the metals to their lowest valence and form bimetallic or trimetallic nanostructure 32. In one instance, the catalyst material 10 can be heated under a hydrogen atmosphere to form a zero valent (e.g., Ni(0)Co(0) or Ni(0)Ru(0)) nanostructure. Without wishing to be bound by theory, it is believed that treating the metal nanostructure with hydrogen can generate larger metal particles from smaller metal oxide particles in the hollow zeolite.

### C. Reformation of Hydrocarbons

Also disclosed is a method of producing hydrogen and carbon monoxide from hydrocarbons under reforming conditions to produce hydrogen (H₂) and carbon monoxide (CO). Reforming includes steam reforming, partial oxidation of hydrocarbon reactions, dry reforming and any combination thereof. Reformation conditions can include contacting the catalyst material 10 with a hydrocarbon feed stream in the presence of an oxidant (e.g., carbon dioxide (CO₂), oxygen (O₂), oxygen enriched air, or any combination thereof) water (H₂O), or both. The water can be in the form of high or low pressure steam. The method includes contacting a reactant gas mixture of a hydrocarbon and oxidant with any one of the supported catalyst materials 10 discussed above and/or throughout this specification under sufficient conditions to produce hydrogen and carbon monoxide at a ratio of 0.35 or greater, from 0.35 to 0.95, or from 0.6 to 0.9. Such conditions sufficient to produce the gaseous mixture can include a temperature range of 600° C. to 950° C. from 750° C. to 950° C. or from 750° C. to 850° C. or from 600° C., 625° C., 650° C., 675° C., 700° C., 725° C., 750° C., 775° C., 800° C., to 900° C., or any value there between and a pressure range of about 1 bara, and/or a gas hourly space velocity (GHSV) ranging from 1,000 to 100,000 h⁻¹. In particular instances, the hydrocarbon includes methane and the oxidant is carbon dioxide. In other aspects, the oxidant is a mixture of carbon dioxide and oxygen. In certain aspects, the carbon formation or coking is reduced or does not occur on the catalyst material 10 and/or sintering is reduced or does not occur on the catalyst material 10. In particular instances, carbon formation or coking and/or sintering is reduced or does not occur when the catalyst 10 is subjected to temperatures at a range of greater than 700° C. or 800° C. or a range from 725° C., 750° C., 775° C., 800° C., 900° C., to 950° C. In particular instances, the range can be from 700° C. to 950° C. or from 750° C. to 900° C.

In instances when the produced catalytic material is used in dry reforming methane reactions, the carbon dioxide in the gaseous feed mixture can be obtained from various sources. In one non-limiting instance, the carbon dioxide can be obtained from a waste or recycle gas stream (e.g. from a plant on the same site, like for example from ammonia synthesis) or after recovering the carbon dioxide from a gas stream. A benefit of recycling such carbon dioxide as starting material in the process of the invention is that it can reduce the amount of carbon dioxide emitted to the atmosphere (e.g., from a chemical production site). The hydrogen in the feed may also originate from various sources, including streams coming from other chemical processes, like ethane cracking, methanol synthesis, or conversion of methane to aromatics. The gaseous feed mixture comprising carbon dioxide and hydrogen used in the process of the invention may further contain other gases, provided that these do not negatively affect the reaction. Examples of such other gases include oxygen and nitrogen. The hydrocarbon material used in the reaction can be methane. The resulting syngas can then be used in additional downstream reaction schemes to create additional products. Such examples include chemical products such as methanol production, olefin synthesis (e.g., via Fischer-Tropsch reaction), aromatics production, carbonylation of methanol, carbonylation of olefins, the reduction of iron oxide in steel production, or the like.

The reactant gas mixture can include natural gas, liquefied petroleum gas comprising C₂-C₅ hydrocarbons, C₆+ heavy hydrocarbons (e.g., C₆ to C₂₄ hydrocarbons such as diesel fuel, jet fuel, gasoline, tars, kerosene, or the like), oxygenated hydrocarbons, and/or biodiesel, alcohols, or dimethyl ether. In particular instances, the reactant gas mixture has an overall oxygen to carbon atomic ratio equal to or greater than 0.9.

The method can further include isolating and/or storing the produced gaseous mixture. The method can also include separating hydrogen from the produced gaseous mixture (such as by passing the produced gaseous mixture through a hydrogen selective membrane to produce a hydrogen permeate). The method can include separating carbon monoxide from the produced gaseous mixture (such as passing the produced gaseous mixture through a carbon monoxide selective membrane to produce a carbon monoxide permeate).

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

### Synthesis of Silicate-1

Silicalite-1 is obtained by mixing tetraethylorthosilicate (TEOS, 98% purity, Sigma-Aldrich®, USA) and tetrapropylammonium hydroxide (TPA(OH), 1.0 M, in H₂O, Sigma-Aldrich®, USA) with water. The gel composition is: SiO₂:0.4 TPA(OH):35H₂O. Then, the mixture is transferred into a Teflon-lined autoclave and heated at 170° C. under static condition for 3 days. The solid was recovery by centrifugation and washed with water, this operation was repeated 3 times. The resulting solid was dried overnight at 110° C. and then calcined at 525° C. in air for 12 h.

### Example 2

### Synthesis of Ni/Hollow-Silicate-1 (HZ) Comparative Catalyst Material

Silicalite-1 from Example 1 was impregnated with aqueous solution of Ni(NO₃)₂.6H₂O (Sigma-Aldrich®, USA) to produce 1.8 wt % of Ni or 5.5 wt. % or Ni on the silicalite-1. The suspension was dried at 50° C. under air over the night. The impregnated silicalite-1 (1 g) was suspended with an aqueous TPA(OH) solution (4.15 in 3.33 mL of H₂O). The mixture was transferred into a Teflon-lined autoclave and heated at 170° C. under static conditions for 24 h. Finally, the 1.8NiHZ was calcined in air at 450° C. for 6 h. Table 1 lists the compositions of the samples.

### Example 3

### General Synthesis Method of Metal Hollow-Silicate-1 Catalyst Material

Silicalite-1 from Example 1 was impregnated silicalite-1 was impregnated with aqueous solution of Ni(NO₃)₂.6H₂O (Sigma-Aldrich®, USA) and Co(NO₃)2.6H₂O (Aldrich) or RuCl₃×H₂O (Aldrich) to produce 5.5 wt % of NiM² (NiCo or NiRu) on the silicalite-1 in a 50/50 mole ratio. The suspension was dried at 50° C. under air over the night. The impregnated silicalite-1 (1 g) was suspended with an aqueous TPA(OH) solution (4.15 in 3.33 mL of H₂O). The mixture is transferred into Teflon-lined autoclave and heated at 170° C. under static conditions for 24 h. Finally, the NiCo/HZ is calcined in air at 450° C. for 6 h. Table 1 lists the compositions of the samples.

TABLE 1

| Sample No. | Catalysts | Compositions |
|---|---|---|
| 1 | Ni/HZ | 1.8 wt % of Ni HZ |
| 2 | Ni/HZ | 5.5 wt % of Ni HZ |
| 3 | NiCo/HZ | 5.5 wt % of Ni/Co (50/50) HZ |
| 4 | NiRu/HZ | 5.5 wt % of Ni/Ru (50/50) HZ |

### Example 4

### Characterization of Catalyst Samples 1-4

Isothermal Analysis.

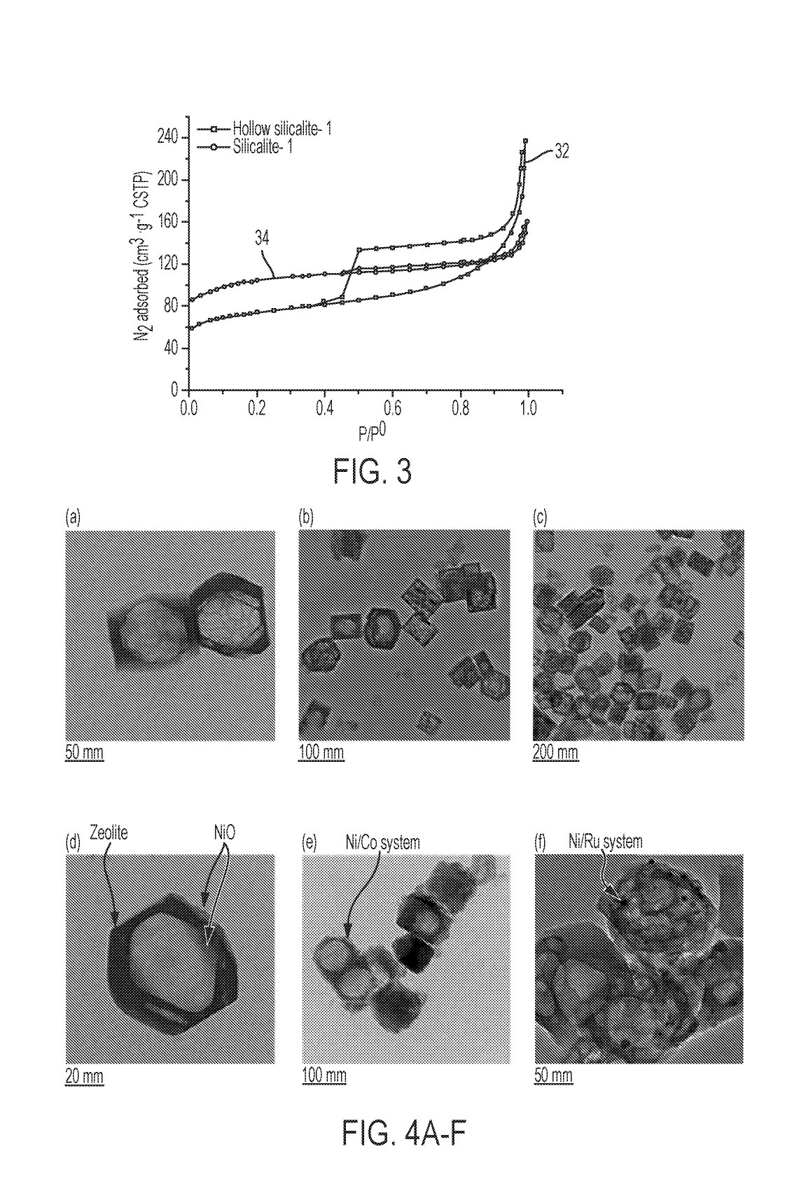

Nitrogen Isotherms of the HZ-1 and silicate-1 using a ASAP 2020 Micromeritics® instrument (Micromeritics®, USA) were obtained. FIG. 3 are isothermal graphs of the silicate-1 and HZ-1. Table 2 lists the BET surface area and pore volumes of each sample. Data line 32 is for the hollow silicate-1 samples and data line 34 is for the HZ-1 samples. The surface area for the HZ-1 catalyst was lower than the surface area for silicate-1 (237 m²g⁻¹ vs. 326 m²g⁻¹). The pore volume for the HZ-1 sample was greater than the pore volume of the silicate-1 sample (0.25 cm³g⁻¹ vs. 36 cm³g⁻¹). Without wishing to be bound by theory, it is believed that the lower BET surface area was due to the dissolution of the silicate-1 core, while the higher pore volume was due to the formation of the hollow.

Transmission Electron Microscopy (TEM).

TEM analysis was performed on comparative sample 2 and inventive catalyst samples 3 and 4. FIG. 4 are TEM images of the comparative catalysts, inventive catalysts and the HZ-1. FIGS. 4A-C are images of the HZ-1. From the image in FIG. 4A a particle size of the HZ-1 was about 150*150*200 nm. FIGS. 4B-C show the homogeneity of the hollow formation on the MFI zeolite structure. FIG. 4D is an image of the Ni/HZ comparative sample, FIG. 4E is an image of the NiCo/HZ catalyst and FIG. 4E is an image of the NiRu/HZ catalyst. The presence of the metals were confirmed by the EDX analysis. From the EDX analysis, it was observed that some metallic oxide on the external surface of the particle.

### Example 5

### Carbon Dioxide Reforming of Methane Reaction (CDRM)

The catalyst (60 g) from Examples 1-3, Table 1, were tested at three 650° C., 750° C., and 800° C. at a pressure of 5 bara, and a gas hourly space velocity (GSHV) of 73,000 h⁻¹ for a gas composition of 10% Argon/5% CO₂/45% methane for 30 hours of operation. The reactor flow was 50 cc.min⁻¹.

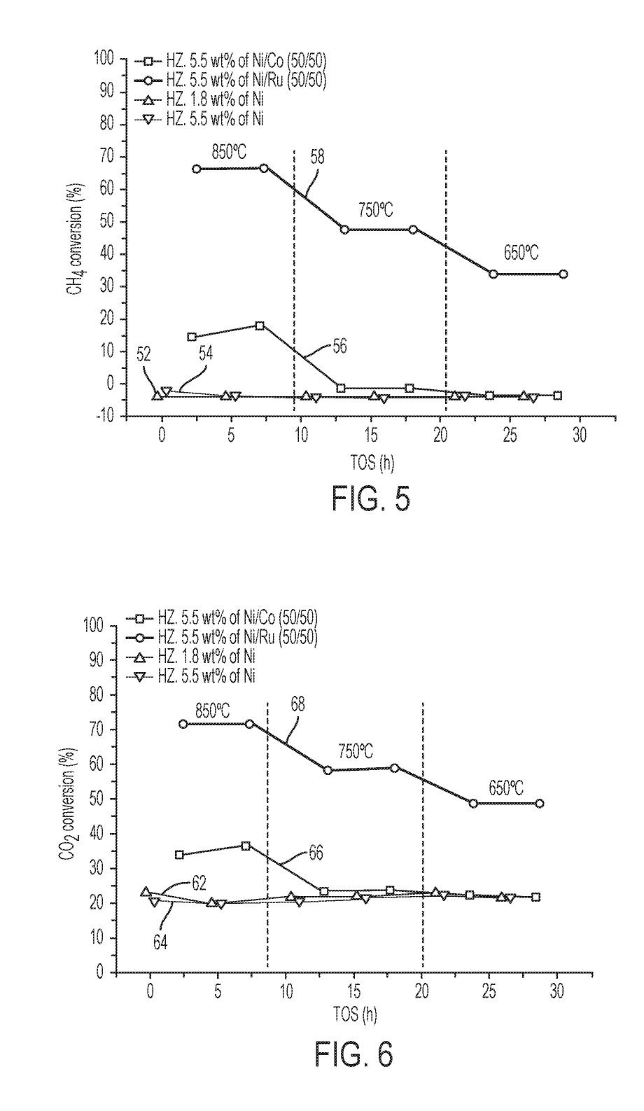

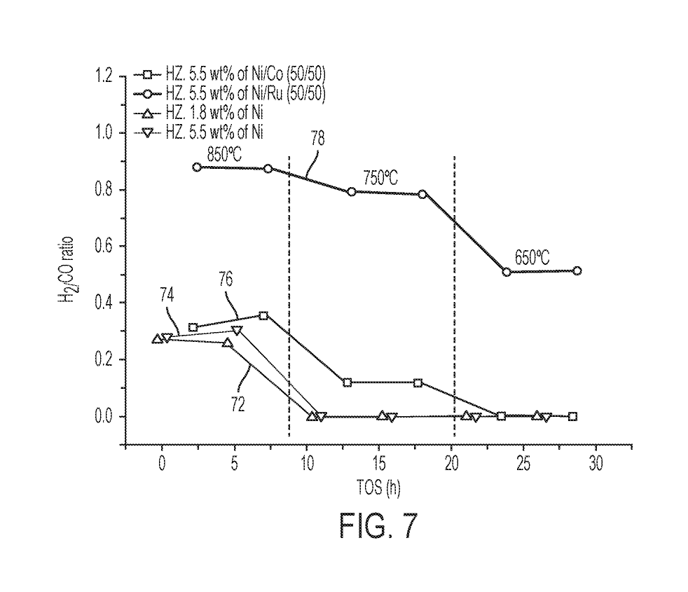

FIG. 5 depicts the CH₄ conversion at different temperatures. Data line 52 is comparative sample 1 (1.8 wt. % Ni/HZ), data line 54 is comparative sample 2 (5.5 wt. % Ni/HZ), data line 56 is inventive catalyst sample 3 (NiCo/HZ), and data line 58 is inventive catalyst sample 4 (NiRu/HZ). FIG. 6 depicts the CO₂ conversion at different temperatures. Data line 62 is comparative sample 1 (1.8 wt. % Ni/HZ), data line 64 is comparative sample 2 (5.5 wt. % Ni/HZ), data line 66 is inventive catalyst sample 3 (NiCo/HZ), and data line 68 is inventive catalyst sample 4 (NiRu/HZ). FIG. 7 depicts the H₂/CO ratio of the different HZ at different temperatures. Data line 72 is comparative sample 1 (1.8 wt. % Ni/HZ), data line 74 is comparative sample 2 (5.5 wt. % Ni/HZ), data line 76 is inventive catalyst sample 3 (NiCo/HZ), and data line 78 is inventive catalyst sample 4 (NiRu/HZ).

Even at 850° C., the comparative samples 1 and 2, 1.8 wt. % Ni/HZ and 5.5 wt. % Ni/HZ, did not show any conversion. However, from the H₂/CO ratio, FIG. 7, it was determined that CO and H₂ was generated. Thus, it was concluded that Ni catalysts in the absence of Co or Ru performed at 850° C. but the yield was very low. When the NiCo/HZ was used, the CH₄ conversion reached 20% at 850° C. and decreased to 3% at 750° C., with little to no production of CO and H₂ at 650° C. It was concluded that Co addition improved the efficiency of the single metal based catalyst at metal loading was very low. In the case of the RuNi system, the CH₄ conversion reached 65% at 850° C., 50% at 750° C. and 35% at 650° C. These results correlated with the H₂/CO ratio equal to 0.9, 0.8 and 0.5 respectively.

The H₂/CO ratio obtained from the NiRu/HZ was greater than 0.5 (See, FIG. 7). The reactions using bimetallic/HZ catalysts provided higher % conversion of methane and carbon dioxide in a shorter period of time than single metal/HZ catalysts. Further, the NiRu/HZ catalyst was found to be stable without any deactivation for 30 hours of duration. Notably, no sintering or coke formation was observed (no appearance of dark black color on catalysts) in any of the catalysts of the present invention at temperatures above 800° C. The lack of coking was confirmed by performing a loss on ignition test of the used catalysts in an open atmosphere at 800° C.

1. A supported catalyst comprising a bimetallic (M¹M²) or trimetallic (M¹M²M³) nanostructure, or oxides thereof, and a hollow zeolite support, wherein:
(a) M¹, M², and if present, M³, are different, with the proviso that if M¹ is Ni, then M² is not platinum (Pt) in the bimetallic (M¹M²) nanostructure; and
(b) the hollow zeolite support comprises an exterior surface and an interior surface that defines and encloses a hollow space within the interior of the support, wherein the bi-metallic (M¹M²) or tri-metallic (M¹M²M³) nanostructure, or oxides thereof, is comprised in the hollow space.

2. The supported catalyst of claim 1, wherein the hollow zeolite support is a silicate-1, MFI, FAU, ITH BEA, MOR, LTA, MWW, CHA, MRE, MFE, or a VFI support.

3. The supported catalyst of claim 1, wherein the nanostructure is a bimetallic (M¹M²) nanoparticle.

4. The supported catalyst of claim 3, wherein M¹ is Ni and M² is either Co or Ru.

5. The supported catalyst of claim 4, wherein M¹ and M² are each 45 to 55 molar % of the total moles of the bimetallic nanostructure.

6. The supported catalyst of claim 5, wherein the hollow zeolite support is 80 to 99.5 wt. % of the supported catalyst.

7. The supported catalyst of claim 1, wherein the hollow space comprises only one bimetallic (M¹M²) or trimetallic (M¹M²M³) nanoparticle, or oxides thereof, or the hollow space comprises a plurality of the bimetallic (M¹M²) or trimetallic (M¹M²M³) nanoparticles, or oxides thereof.

8. The supported catalyst of claim 1, wherein the bimetallic (M¹M²) or trimetallic (M¹M²M³) nanoparticle, or oxides thereof, is deposited on the interior surface of the hollow zeolite support.

9. The supported catalyst claim 1, further comprising at least one additional bimetallic (M¹M²) or trimetallic (M¹M²M³) nanoparticle, or oxides thereof, deposited on the exterior surface.

10. The supported catalyst of claim 1, wherein the size of the hollow space and the bimetallic (M¹M²) or trimetallic (M¹M²M³) nanoparticle, or oxides thereof, are larger than the average pore size of the pores in the hollow zeolite support.

11. The supported catalyst of claim 10, wherein the average particle size of the bimetallic (M¹M²) or trimetallic (M¹M²M³) nanoparticle, or oxides thereof, is 1 to 100 nm, preferably 1 to 30 nm, more preferably 3 to 15 nm, most preferably ≤10 with a size distribution having a standard deviation of ±20%.

12. The supported catalyst of claim 1, wherein M¹ and M² are each 1 to 20 weight % of the total weight of the bimetallic nanostructure or wherein M¹, M², and M³ are each 1 to 20 weight % of the total weight of the trimetallic nanostructure.

13. The supported catalyst of claim 1, wherein the hollow zeolite support is 80 to 99.5 wt. % of the supported catalyst.

14. The supported catalyst of claim 1, wherein the catalyst is configured to catalyze a hydrocarbon reformation reaction.

15. The supported catalyst of claim 14, wherein the reformation reaction is a dry reformation of methane reaction or a steam reformation reaction, preferably a steam reformation reaction.

16. A method of producing H₂ and CO comprising contacting a reactant gas stream that includes hydrocarbons and CO₂ or H₂O with the supported catalyst of claim 1 sufficient to produce a product gas stream comprising H₂ and CO.

17. The method of claim 16, wherein coke formation on the supported nanostructure catalyst is substantially or completely inhibited.

18. The method of claim 16, wherein the reactant gas stream comprises C₁ to C₈ hydrocarbons, preferably methane, and CO₂ or the reactant gas stream comprises C₁ to C₈ hydrocarbons, preferably methane, and H₂O and optionally O₂, or the reactant gas stream comprises C₁ to C₈ hydrocarbons, preferably methane, and H₂O and CO₂ and H₂O.

19. The method of claim 16, wherein the reaction conditions include a temperature of about 700° C. to about 950° C., a pressure of about 0.1 MPa to 2.5 MPa, and a gas hourly space velocity (GHSV) ranging from about 500 to about 100,000 h⁻¹.

20. A method of making the supported catalyst of claim 1, the method comprising:
(a) obtaining a zeolite support;
(b) obtaining a first suspension by suspending the zeolite support in an aqueous solution having a M¹ precursor material, a M² precursor material, and optionally a M³ precursor material for a sufficient period of time to impregnate the support with the precursor material and drying the first suspension to obtain an impregnated support;
(c) obtaining a second suspension by suspending the impregnated support from step (b) in an aqueous solution comprising a templating agent, preferably tetrapropylammonium hydroxide (TPAOH), and thermally treating the suspension to obtain a templated support; and
(d) calcining the templated support to obtain the supported catalyst of claim 1.
